(19) United States
(12) Patent Application Publication
(10) Pub. No.: US 2023/0359933 A1
(43) Pub. Date: Nov. 9, 2023

(54) MACHINE LEARNING SYSTEMS CONFIGURED TO GENERATE LABELED TIME SERIES DATASETS FOR MANUFACTURING OPERATIONS

(71) Applicant: 3M INNOVATIVE PROPERTIES COMPANY, St. Paul, MN (US)

(72) Inventors: Karthik Subramanian, St. Paul, MN (US); Anish R. Kunduru, South St. Paul, MN (US); Nicholas John Blum, Woodbury, MN (US)

(21) Appl. No.: 18/141,628

(22) Filed: May 1, 2023

Related U.S. Application Data
(60) Provisional application No. 63/338,277, filed on May 4, 2022.

(51) Int. Cl. G06N 20/00

(52) U.S. Cl. CPC G06N 20/00

(57) ABSTRACT

A method includes obtaining annotated seed data comprising one or more tags associated with corresponding timing data and a respective label, training a semi supervised learning algorithm (SSLA) using the annotated seed data to form a trained SSL model, executing the trained SSL model using unlabeled time series process data as an input, wherein the unlabeled time series process data includes tags different from the tags of the annotated seed data to output a pre-validation labeled time series process dataset, obtaining output evaluation data associated with the pre-validation labeled time series process dataset, iteratively retraining the trained SSL model using the output evaluation data, determining that the trained SSL model has reached convergence based on the output evaluation data indicating that the trained SSL model outputs validated labeled time series data, and in response to determining that the trained SSL model has reached convergence, deploying the trained SSL model.

This application claims the benefit of U.S. Provisional Patent Application No. 63/338,277 filed on 4 May 2022, the entire contents of which are incorporated by reference herein.

### SUMMARY

Manufacturing sites are often a source of rich, voluminous legacy data describing various processes, equipment, and/or programmer logic controllers (PLCs) related to the sites. The increasing trend towards automation and data exchange in manufacturing technologies (e.g., cyber-physical systems, the Internet of Things (IoT), cloud computing, cognitive computing, and creation of so-called “smart factories”) is sometimes referred to as the “fourth industrial revolution” or “Industry 4.0.” Artificial intelligence (AI), machine learning (ML), and data science are some of the tools or key drivers that help manufacturing entities derive real-time or near real-time feedback on the performance of various factory line equipment.

AI/ML algorithms tend to perform better with greater use of labeled data. As such, a lack of labeled datasets diminishes the performance of trained AI/ML models, whether in the context of Industry 4.0 or otherwise. Various complexities and idiosyncrasies associated with manufacturing-related data further exacerbate the performance diminishments caused by using unlabeled data to train or execute AI/ML models. The growing prevalence of Industry 4.0 has driven the adoption of unsupervised ML models to address key issues in the manufacturing space. Unsupervised ML-based techniques present challenges, however, such as the requirement of greater involvement from plant engineers to validate findings of the trained models using historical data related to the plant or manufacturing facility.

In one example, a system includes interface hardware, a memory communicatively coupled to the interface hardware, and processing circuitry communicatively coupled to the memory and the interface hardware. The interface hardware is configured to obtain annotated seed data comprising one or more tags associated with corresponding timing data and a respective label. The memory is configured to store the annotated seed data, a semi-supervised learning algorithm (SSLA), and unlabeled time series process data. The unlabeled time series process data includes tags different from the tags of the annotated seed data to output a pre-validation labeled time series process dataset. The processing circuitry is configured to train the SSLA using the annotated seed data to form a trained semi-supervised learning (SSL) model, to execute the trained SSL model using the unlabeled time series process data as an input, and to obtain, via the interface hardware, output evaluation data associated with the pre-validation labeled time series process dataset. The processing circuitry is further configured to iteratively retrain the trained SSL model using the output evaluation data, to determine that the trained SSL model has reached convergence based on the output evaluation data indicating that the trained SSL model outputs a validated labeled time series dataset, and to control, in response to determining that the trained SSL model has reached convergence, control the interface hardware to deploy the trained SSL model.

In another example, a method includes obtaining annotated seed data that includes one or more tags associated with corresponding timing data and a respective label and training a semi-supervised learning algorithm (SSLA) using the annotated seed data to form a trained semi-supervised learning (SSL) model. The method further includes executing the trained SSL model using unlabeled time series process data as an input, where the unlabeled time series process data includes tags different from the tags of the annotated seed data to output a pre-validation labeled time series process dataset and obtaining output evaluation data associated with the pre-validation labeled time series process dataset. The method further includes iteratively retraining the trained SSL model using the output evaluation data, determining that the trained SSL model has reached convergence based on the output evaluation data indicating that the trained SSL model outputs a validated labeled time series dataset, and in response to determining that the trained SSL model has reached convergence, deploying the trained SSL model.

In another example, an apparatus includes means for obtaining annotated seed data comprising one or more tags associated with corresponding timing data and a respective label, means for training a semi-supervised learning algorithm (SSLA) using the annotated seed data to form a trained semi-supervised learning (SSL) model, and means for executing the trained SSL model using unlabeled time series process data as an input, where the unlabeled time series process data includes tags different from the tags of the annotated seed data to output a pre-validation labeled time series process dataset. The apparatus further includes means for obtaining output evaluation data associated with the pre-validation labeled time series process dataset, means for iteratively retraining the trained SSL model using the output evaluation data, means for determining that the trained SSL model has reached convergence based on the output evaluation data indicating that the trained SSL model outputs a validated labeled time series dataset, and means for deploying the trained SSL model in response to the determination that the trained SSL model has reached convergence.

In another example, a non-transitory computer-readable storage medium is encoded with instructions that, when executed, cause processing circuitry of a computing device to obtain annotated seed data comprising one or more tags associated with corresponding timing data and a respective label, to train a semi-supervised learning algorithm (SSLA) using the annotated seed data to form a trained semi-supervised learning (SSL) model, to execute the trained SSL model using unlabeled time series process data as an input, where the unlabeled time series process data includes tags different from the tags of the annotated seed data to output a pre-validation labeled time series process dataset, to obtain output evaluation data associated with the pre-validation labeled time series process dataset, to iteratively retrain the trained SSL model using the output evaluation data, to determine that the trained SSL model has reached convergence based on the output evaluation data indicating that the trained SSL model outputs a validated labeled time series dataset, and deploy the trained SSL model in response to the determination that the trained SSL model has reached convergence.

Aspects of this disclosure are directed to systems and techniques for more effectively applying data science to aid manufacturing processes. More specifically, certain aspects of this disclosure provide data annotation and labeling systems that leverage seed data to then generate more expansive labeled time series datasets. The labeled time series datasets generated by the ML models of this disclosure can be used as training data or execution phase input data with respect to AI/ML models that are deployed to detect manufacturing conditions that do not conform to normal operating conditions (NOC).

The systems of this disclosure provide several technical improvements in the technical field of data science. As one example, the systems of this disclosure provide scalability by extrapolating varying (and potentially highly voluminous) quantities of labeled datasets from a relatively smaller subset of labeled seed data. As another example, the systems of this disclosure improve data precision by mitigating or potentially even eliminating human error that could occur in cases of manual annotation and labeling, particularly in scenarios in which more voluminous quantities of datasets are extrapolated from the seed data. By extrapolating annotations available from the labeled seed data across broader, richer, and more voluminous datasets in this way, the systems of this disclosure provide scalability improvements, data precision improvements, and reduced computing resource expenditure in the form of computing time that would otherwise be required for error correction.

Implementations of the subject matter described herein include computer-implemented methods that can be carried out by a system of one or more computers in one or more locations (e.g., via local computing, distributed computing, software as a service (SaaS), etc.) in various examples. The details of various implementations of the subject matter described in this specification are set forth in the accompanying drawings and the description below. Other features, aspects, and advantages of the subject matter will be apparent from the description, the drawings, and the claims.

### BRIEF DESCRIPTION OF DRAWINGS

FIG. 1 is a conceptual diagram illustrating an example workflow of this disclosure.

FIG. 2 is a conceptual diagram illustrating another example workflow of this disclosure.

FIG. 3 is a flowchart illustrating an example process by which systems of this disclosure form a trained semi-supervised learning model.

FIG. 4 is a block diagram illustrating an example implementation of a system of this disclosure.

### DETAILED DESCRIPTION

Systems of this disclosure address various data precision, scalability, and manufacturing-related resource issues in the adoption of Industry 4.0. Manufacturing entities have looked to incorporate AI/ML algorithms into site management operations in an attempt to improve manufacturing-related efficiencies and to more proactively address unpredictability arising from performance variations (even if the variations are subtle) of manufacturing line equipment and/or processes. While AI/ML-driven intelligent manufacturing systems can provide automated ways to identify issues and provide error resiliency, the lack of labelled datasets presents a significant challenge in driving widespread adoption of AI/ML-based solutions in this area. Without access to larger quantities of labeled data, the effectiveness of AI/ML algorithms in the manufacturing space is limited. More specifically, with limited or no access to labeled datasets, the data precision of the solutions delivered by AI/ML tools in the context of Industry 4.0 is poor.

Systems of this disclosure generate broader labeled datasets for manufacturing operations by leveraging a smaller subset of previously labeled “seed” data. The systems described herein leverage NOC scenarios as opposed to edge case scenarios or “anomalies” identified in the seed data to extrapolate broader labeled datasets. The broader labeled time series datasets generated by the systems of this disclosure can be used as inputs to AI/ML algorithms that detect anomalies or so-called “edge cases” that deviate from NOC scenarios. Various levels of labeling granularity are compatible with aspects of this disclosure. One example is a binary labeling scheme that differentiates edge cases from NOC scenarios. In other examples, the systems of this disclosure may use the labeled seed data to generate datasets that are labeled at greater than two levels, such as by using an NOC in addition to multiple different types of anomalous labels. The systems of this disclosure are also compatible with different types of AI/ML models that can be used to generate the broader labeled datasets, such as deep learning models, classical ML models, etc.

The systems of this disclosure provide several technical improvements in the technical field of AI/ML model deployment, particularly when these models are deployed in the context of manufacturing site management. As one example, the systems of this disclosure improve data precision by reducing or potentially eliminating the occurrence of false positives when identifying anomalies in site functions, such as by making the execution of AI/ML models more accurate. As another example, the systems of this disclosure improve the efficiency of data science usage in manufacturing environments, thereby reducing computing resource and bandwidth consumption that would otherwise be required for error resiliency. The systems of this disclosure may also reduce the cost of goods sold (COGS) of the output of the manufacturing lines, and eliminate the human capital costs of manual analysis of manufacturing site data for deviations from NOC scenarios.

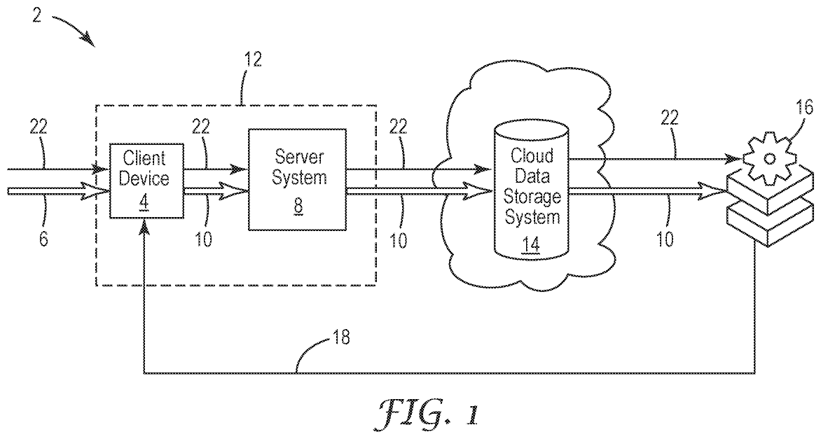

FIG. 1 is a conceptual diagram illustrating workflow 2 of this disclosure. In accordance with workflow 2, client device 4 may implement an interactive user interface (UI) that enables a user to input seed data along with labels. For instance, client device 4 may receive, via the interactive UI, seed data that includes a subset of time series data (shown in FIG. 1 as seed data 6) reflecting manufacturing process performance collected from one or more manufacturing sites. Seed data 6 may include one or more of timing information (such as a specific time or a time frame) associated with manufacturing process events, tags (which may include readings or readouts such as pressure measurements, temperature measurements, torque metrics, etc.) collected from manufacturing line equipment, and/or labels.

In one non-limiting use-case scenario, client device 4 may receive seed data 6 via the interactive UI from a user, such as a process engineer. In this particular example, seed data 6 includes a subset (e.g., a group of ten to one hundred) manufacturing-related events that the process engineer identifies as being “anomalous.” For example, the interactive UI provided by client device 4 may be operable to enable the process engineer to drag and drop UI elements corresponding to this subset of events into an area corresponding to an “anomalous” label.

In some instances, client device 4 may receive user input affirmatively identifying certain events as NOC events, while in other instances, all events not identified with the anomalous label are identified as NOC events by default. This particular use-case scenario is an example of a “binary” or “two-class” dataset labeling scheme in accordance with aspects of this disclosure. As discussed in greater detail below, the systems of this disclosure are also compatible with multi-class dataset labeling mechanisms that incorporate greater than two classes of labels.

Client device 4 may also associate timing information with each respective manufacturing-related event represented in seed data 6. In various examples, client device 4 may associate a timestamp with one or more of the events and/or time ranges with one or more of the events represented in seed data 6. By associating timing information with the respective events represented in seed data 6, client device 4 implements preprocessing techniques of this disclosure to generate data that identifies times or timeframes at which anomalies occurred in a manufacturing process pipeline.

Seed data 6 may also include information referred to herein as “tags.” As used herein, tags refer to data readouts obtained from manufacturing line equipment. As described above, some non-limiting examples of tags in accordance with this disclosure are temperature measurements, pressure measurements, or torque metrics. The tags included in seed data 6 may provide indications of the nature of or the root cause or an intermediate cause of a manufacturing process anomaly.

In some cases, the tag itself may form the anomaly (e.g., a torque spike read from a piece of manufacturing line equipment may indicate an anomalous condition), while in other cases, a tag may be a root or intermediate cause (e.g., an exacerbating factor or a synergistic factor) of an anomaly that occurred downstream of the location of the tag readout on the manufacturing line. Non-limiting examples of tags include process variables (e.g., one or more variables that are measured from manufacturing line equipment), a setpoint (e.g., a temperature that is a desirable outcome at a particular point of the manufacturing line), or an output (e.g., the end product of the manufacturing process).

Server system 8 may obtain annotated seed data 10 from client device 4. Annotated time series seed data 10 represents a preprocessed version of seed data 6 that was received via the interactive UI implemented by client device 4. That is, annotated time series seed data 10 represents a labeled dataset corresponding to the events and tags represented in seed data 6, with timing information associated to the labeled data. In the particular example described with respect to the binary labeling scheme of this disclosure, client device 4 may generate annotated time series seed data 10 to include one or more instances of events/tags that are labeled as “anomalous.”

Optionally, in some scenarios in which client device 4 uses the binary labeling scheme of this disclosure, annotated time series seed data 10 may also include one or more events/tags that are explicitly labeled as “NOC.” In this way, in various examples, client device 4 may generate annotated time series seed data 10 in a format that affirms NOC events/tags in addition to anomalous events/tags, or in other examples, may generate client device 4 may generate annotated time series seed data 10 in a format that enables downstream devices to infer NOC events/tags based on non-fulfillment of anomalous label requirements.

Server system 8 may store annotated time series seed data 10 within frontend block 12 of workflow 2. Server system 8 may service one or more manufacturing sites, and may obtain and store annotated time series datasets obtained from multiple client devices, in some scenarios. Purely for the purposes of ease of illustration and discussion, server system 8 is shown in FIG. 1 as obtaining labeled data (in the form of annotated time series seed data 10) from a single client device, namely, client device 4. It will be appreciated that server system 8 may, in other implementations, provide data scalability by sourcing annotated time series datasets from multiple client devices, potentially corresponding to multiple pieces of manufacturing line equipment and/or multiple manufacturing sites.

Server system 8 may upload or “push” various annotated time series datasets to cloud data storage system 14. It will be appreciated that server system 8 may aggregate and push larger amounts of annotated time series datasets, representing seed data from one or more of multiple manufacturing sites, multiple time series, and/or multiple pieces of manufacturing line equipment to cloud data storage system 14. Purely for the purposes of ease of illustration and discussion, however, FIG. 1 is illustrated and described herein with respect to server system 8 pushing annotated time series seed data 10 to cloud data storage system 14. Cloud data storage system 14 represents a “data store” block or stage of the pipelined process represented by workflow 2.

AI/ML model 16 may obtain annotated time series seed data 10 as training data from cloud data storage system 14. That is, AI/ML model 16 may train on annotated time series seed data 10 to move towards a stable state or a state of convergence by which a fully trained version of AI/ML model 16 would be configured to generate labeled time series datasets using a set of unlabeled manufacturing events/tags that is broader than seed data 6. In this way, techniques of this disclosure provide technical improvements of data precision and scalability in the technical field of dataset labeling by providing a mechanism (in this example, the trained version of AI/ML model 16) that generates broader, accurately labeled datasets, from a smaller subset of labeled data (namely, annotated time series seed data 10 in this particular example).

Workflow 2 includes a feedback loop by which the output of AI/ML model 16 (shown in this example as labeled time series data 18) loops back to frontend block 12 for evaluation/validation. As shown in FIG. 1, as part of the training process, AI/ML model 16 feeds labeled time series data 18 back to client device 4. Client device 4 receives labeled time series data 18 and outputs some or all of labeled time series data 18 via the interactive UI. In turn, client device 4 may receive, via the interactive UI, input data that confirms or rejects labels, on a label-by-label basis, of labeled time series data 18. Client device 4 may forward output evaluation data 22 through the pipelined process of workflow 2 to AI/ML model 16 for retraining purposes.

Output evaluation data 22 reflects the confirmations and/or rejections of labeled time series data as received at client device 4. That is, AI/ML model 16 may refine its training for labeled dataset generation using output evaluation data 22. In this way, systems of this disclosure leverage adversarial retraining aspects to retrain AI/ML model 16 and improve the data precision of labeled time series data 18. AI/ML model 16 may iterate the feedback loop represented by labeled time series data 18 and output evaluation data 22 any number of times until AI/ML model 16 reaches convergence (also referred to as a “stable state”).

Systems of this disclosure are pluggable in that AI/ML model 16 may conform to any of a number of types of models while reaching convergence and providing labeled time series data 18 in an accurate manner. In some examples, AI/ML model 16 may conform to a deep learning architecture. One example of a deep learning architecture consistent with AI/ML model 16 is an autoencoder model. In other examples, AI/ML model 16 may conform to a classical ML architecture. Examples of classical ML architectures to which AI/ML model 16 may conform include estimated maximization (EM) algorithms and/or probabilistic classification models, such as a naive Bayes classifier.

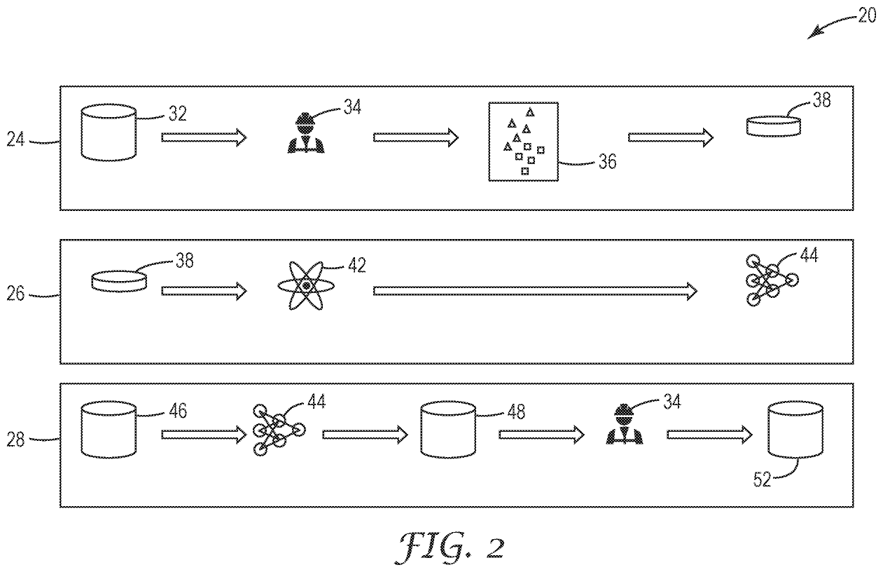

FIG. 2 is a conceptual diagram illustrating workflow 20 of this disclosure. Workflow 20 is a detailed representation of the AI/ML-based annotated dataset generation techniques of this disclosure. Workflow 20 comprises three phases, namely, preprocessing phase 24, training phase 26, and validation phase 28. Preprocessing phase 24 entails the generation of seed data 10 described above with respect to FIG. 1. As part of preprocessing phase 24, a user, such as subject matter expert (SME) 34, may use the interactive UI provided by client device 4 to annotate raw process data 32.

For example, the interactive UI provided by client device 4 may represent a user-facing layer of the development stack of a trending tool executed by one or more devices of frontend block 12. Using the combination of raw data 32 and annotations 36 provided by SME 34 via the interactive UI, the device(s) of frontend block 12 may generate labeled subset dataset 38. Labeled subset dataset 38 is one example embodiment of annotated time series seed data 10. Labeled subset dataset 38 may include timing information (e.g., a time period), labels 36, and a set of tags from raw data 32.

Training phase 26 may begin with labeled subset dataset 38 being supplied as training data to semi-supervised learning algorithm (SSLA) 42. In various examples consistent with this disclosure, SSLA 42 may represent an EM algorithm, a naïve Bayes algorithm, an autoencoder algorithm, etc. By training SSLA 42 on labeled subset dataset 38, systems of this disclosure may form trained semi-supervised learning (SSL) model 44.

Validation phase 28 may begin by executing trained SSL model 44 using unlabeled time series process data 46. Unlabeled time series process data 46 is raw data in that unlabeled time series process data 46 does not include NOC or “anomalous” labels, or any other labels in cases of using a more granular labeling scheme of this disclosure. In its execution phase, trained SSL model 44 may use unlabeled time series process data 46 as input data to generate pre-validation labeled time series process dataset 48. Client device 4 may output pre-validation labeled time series process dataset 48 via the interactive UI, and receive validation input from SME 34 via the interactive UI.

Device(s) of frontend block 12 may parse the validation input received from SME 34 to obtain confirmation inputs and/or correction inputs with respect to pre-validation labeled time series process dataset 48. In instances in which client device 4 obtains a confirmation input, the device(s) of frontend block 12 may validate the corresponding label generated by trained SSL model 44. In instances in which the device(s) of frontend block 12 obtains a correction input, the device(s) of frontend block 12 may change the corresponding label generated by trained SSL model 44 to reflect the correct label identified in the correction input.

By applying any corrections reflected in the validation input to pre-validation labeled time series process dataset 48, the device(s) of frontend block 12 may generate validated labeled time series process dataset 52. Validation phase 28 may repeat for any numbers of iterations until the retraining represented by validation phase 28 until trained SSL model 44 reaches a stable state (or “convergence”). In some examples, client device 4 may receive an input from SME 34 explicitly designating trained SSL model 44 as being in a stable state.

In other examples, the device(s) of frontend block 12 may infer that trained SSL model 44 has reached a stable state based on one or more factors, such a single instance or a threshold number of consecutive instances of the validation input including only confirmations or at least a threshold number of confirmations. In this manner, validation phase 28 incorporates aspects of adversarial learning and/or reinforcement learning in the retraining/refinement of trained SSL model 44.

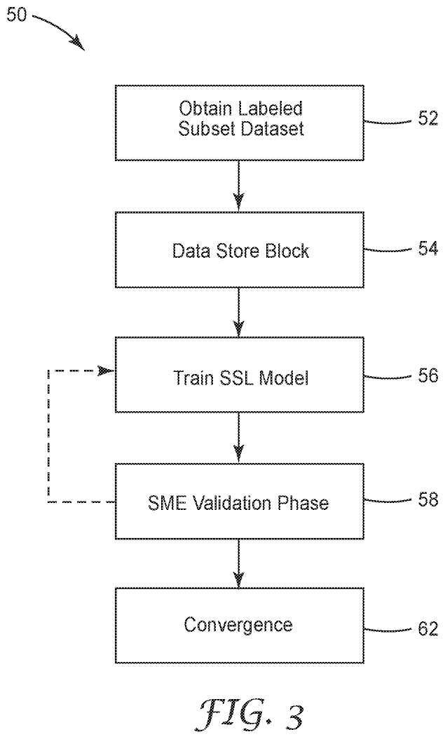

FIG. 3 is a flowchart illustrating an example process 50 by which systems of this disclosure form trained SSL model 44. As such, process 50 describes a training phase of the AI/ML models of this disclosure. Process 50 may begin with the device(s) of frontend block 50 obtaining labeled subset dataset 38 (52). For example, client device 4 may execute the user-facing layer of a frontend tool to elicit and ingest labeled subset dataset 38, sometimes in multiple phases, such as by receiving seed data 6 and separately receiving labels corresponding to the tags/events of seed data 6 to form labeled subset dataset 38.

For instance, the UI operated by client device 4 may enable SME 34 to visualize or “trend” the process data of a manufacturing equipment or facility and enter annotations/labels events specific to a tag or group of tags over a particular time period. As one non-limiting use-case example, SME 34 may label a torque spike via the UI, while also linking the torque spike event to a particular time range during which the event (in this case, the torque spike) occurred. Server system 8 may log the tag name, time range, and annotation (label) to a database. The UI operated by the devices of frontend block 12 may provide the capability for SME 34 and/or other duly authorized users to reassign labels across events of interest.

In turn, process 50 may transition to a data store block (54). Data store block 54 serves as a entry point data store in the cloud for training phase 26 of SSLA 42. Cloud data storage system 14 of FIG. 1 may implement some or all of the functionalities described with respect to data store block 54. In turn, cloud data storage system 14 may train SSLA 42 (56). For instance, cloud data storage system 14 may train SSLA 42 using historical data such as pre-validation labeled time series process dataset 48, which may include incoming data from the manufacturing line.

Cloud data storage system 14 may run trained SSL model 44 in its execution phase as part of an SME validation phase (58). For example, cloud data storage system 14 may cause client device 4 to output the execution-phase results produced by trained SSL model 44 to SME 34 via the interactive UI in the form of a feedback loop. For example, client device 4 may output the results produced by trained SSL model 4 when run on actual raw historical data collected from one or more manufacturing lines or sites. In some examples, cloud data storage system 14 and/or the device(s) of frontend block 12 may be configured to filter the output to remove redundancies, outliers, or certain false positives that are easy to detect.

Client device 4 may receive output evaluation data 22 from SME 34 via the interactive UI. The device(s) of frontend block 12 may provide the output of trained SSL model 44 and output evaluation data 22 back to cloud data storage system 14 (returning to step 56) as part retraining trained SSL model 44 to refine its execution-phase output. Upon retraining to a sufficient level of execution-phase output accuracy, cloud data storage system may detect that trained SSL model 44 has reached a stable state or “convergence” (62).

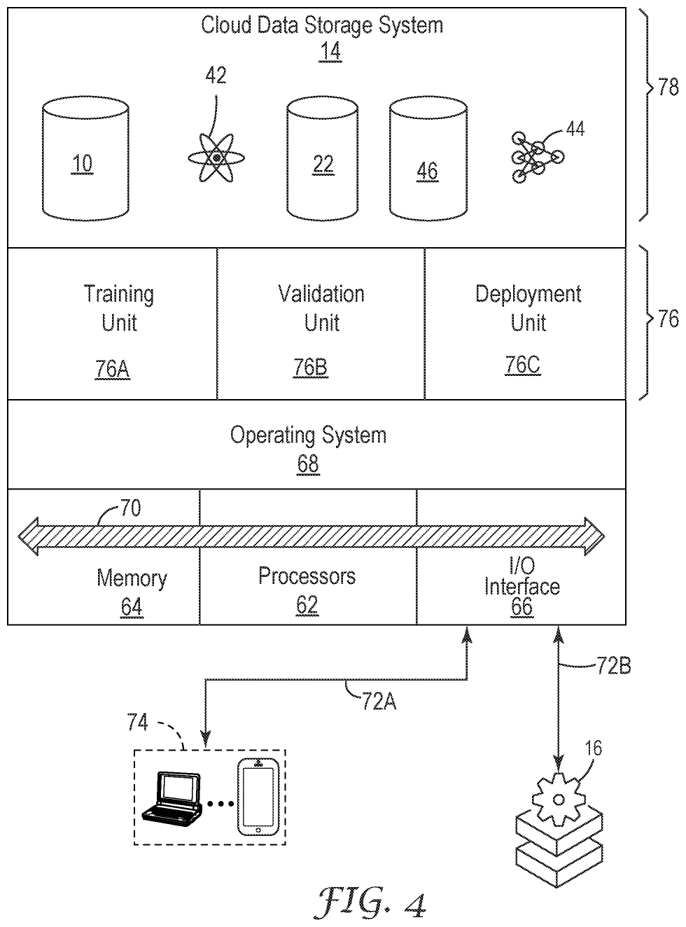

FIG. 4 is a block diagram illustrating an example implementation of cloud data storage system 14. While FIG. 4 shows one implementation of cloud data storage system 14 that is consistent with aspects of this disclosure, it will be appreciated that other architectures (whether single-device or distributed architectures) of cloud data storage system 14 are consistent with aspects of this disclosure, as well.

In the example of FIG. 4, cloud data storage system 14 includes one or more processors 62 and memory 64. In some examples, memory 64 and processors 62 may be integrated into a single hardware unit, such as a system on a chip (SoC) or integrated circuit (IC). Each of processors 62 may comprise one or more of a multi-core processor, a controller, a digital signal processor (DSP), an application specific integrated circuit (ASIC), a field-programmable gate array (FPGA), processing circuitry (e.g., fixed function circuitry, programmable circuitry, or any combination of fixed function circuitry and programmable circuitry) or equivalent discrete logic circuitry or integrated logic circuitry. Memory 64 may include any form of memory for storing data and executable software instructions, such as random-access memory (RAM), read-only memory (ROM), programmable read only memory (PROM), erasable programmable read-only memory (EPROM), electronically erasable programmable read only memory (EEPROM), and flash memory.

Memory 64 and processor(s) 62 provide a computer platform for executing operation system 68. In turn, operating system 68 provides a multitasking operating environment for executing one or more software components 14. As shown, processors 62 connect via an input/output (I/O) interface 66 to external systems and devices via one or more communicative networks, such as any one or more of a data-enabled telephony network (such as a cellular data network), a wide-area network (such as the Internet), a public network (such as the Internet), a private network, such as a local-area network (LAN) and/or an enterprise network, or any other type of network that enables data communications, or any combination of any two or more of the networks listed above. I/O interface 66 may incorporate network interface hardware, such as one or more wired and/or wireless network interface controllers (NICs) for communicating via communications links 36 and 38.

In the particular example of FIG. 4, communications links 72A and 72B (collectively, “communications links 72”) represent one or more network-enabled communicative connections, such as a link to one or more packet-switched networks or other communicative networks. One or both of communications links 72 may represent any of a data-enabled telephony network (such as a cellular data network), a wide-area network (such as the Internet), a public network (such as the Internet), a private network, such as a local-area network (LAN) and/or an enterprise network, or any other type of network that enables data communications, or any combination of any two or more of the networks listed above.

Each of communications links 72 represents a communicative connection implemented over a communicative network that may include, be, or be part of one or more wired connections (e.g., an Ethernet® connection), wireless connections (e.g., a Wi-Fi′ connection) or a combination of both wired and wireless communicative connections. Communications link 72A couples cloud data storage system 14 to remote devices 74. Remote devices 74 may include one or more of the devices of frontend block 12 of FIG. 1, and in some examples, may include various devices deployed to locations such as the same factory setting as the devices associated with frontend block 12 and/or devices deployed to locations different from the factory setting associated with frontend block 12.

In the example illustrated in FIG. 4, I/O interface 66 also facilitates communication between cloud data storage system 14 and a system that trains and retrains AI/ML model 16 via communications link 72B. Communications link 72B may represent any of the network-based connections listed above, or may represent one or more local connections, such as a connection to the system that trains and retrains AI/ML model 16 via a local area network (LAN) and/or personal area network (PAN) connections, such as one or more of near-field communication (NFC) pairings, Bluetooth® pairings, Zigbee® pairings, or the like. Communications link 72B may communicatively couple cloud data storage system 14 (by way of I/O interface 66) to a device that includes, among other hardware infrastructure, one or more processing units that can read and process annotated time series seed data 10 and/or output evaluation data 22. These processing unit(s) of the system that trains and retrains AI/ML model 16 may read and process annotated time series seed data 10 and/or output evaluation data 22 to bring AI/ML model 16 to a stable state. In some examples, these processing unit(s) of the system that trains and retrains AI/ML model 16 can utilize an one or more AI engine(s) and/or ML engine(s) to process annotated time series seed data 10 and/or output evaluation data 22 to bring AI/ML model 16 to the stable state and optionally, to deploy AI/ML model 16 (e.g., back to cloud data storage system 14 and/or to other devices that can run the trained model in an execution phase) once it reaches convergence.

Bus 70 provides inter-component connectivity between processors 62, memory 64, and I/O interface 66 in the implementation shown in FIG. 4. Bus 70 may represent a half-duplex or full-duplex bus that provides data transfer capabilities between two or more of processors 62, memory 64, I/O interface 66, and/or any other hardware components of cloud data storage system 14. Bus 70 may represent a system bus or a computer bus of various types, including one or more bus networks. Regardless of the topology implemented, bus 70 may, in various examples, incorporate various types of inter-component connectivity hardware such as those conforming to any of first generation, second generation, third generation, or fourth generation bus or bus network technology as set forth by the Institute of Electrical and Electronics Engineers (IEEE), and/or other bus or bus network technologies defined in developing or later-adopted standards.

Software components 76 of cloud data storage system 14, in the particular example of FIG. 1, include training unit 76A, validation unit 76B, and deployment unit 76C. In some example approaches, one or more of software components 76 represent executable software instructions that may take the form of one or more software applications, software packages, software libraries, hardware drivers, and/or Application Program Interfaces (APIs). Moreover, any of software components 76 may, when executed, cause cloud data storage system 14 to output data and/or receive data via I/O interface 66.

Aspects of memory 64 that provide non-volatile storage and/or long-term storage support local storage of data repositories 78. In the example of FIG. 4, data repositories 78 include annotated seed data 10, SSLA 42, output evaluation data 22, unlabeled time series process data 46, pre-validation labeled time series process dataset 48, and trained SSL model 44. One or more of software components 76 may invoke processors 62 and memory 64 to access one or more of data repositories 78 to retrieve data for various purposes, such as for model training, retraining, or deployment.

In some examples, software components 76 may implement read/write capabilities with respect to data repositories 78, such as to access and use information available from data repositories 78 and/or to modify information currently stored to data repositories 78. In implementations in which cloud data storage system 14 represents a distributed computing system, one or more of data repositories 78 may be positioned at a remote location from processors 62, and software components 14 may, in these implementations, access data repositories 78 using NIC hardware of I/O interface 66.

Cloud data storage system 14 may obtain annotated seed data 10 from remote devices 74 via communications link 72A, and store annotated seed data 10 locally or in a distributed fashion. Training unit 76A may access annotated seed data 10 and use annotated seed data 10 to train SSLA 42. Again, annotated seed data 10 may reflect events across time periods and across tag lists that are labeled via user input, such as input entered by SME 34 via one or more of remote devices 74. Examples of labels (in binary labeling schemes) included in annotated seed data 10 include anomaly versus NOC, web-break versus non-web-break, torque spike versus stable torque, transient versus steady, stable versus unstable, etc.

The binary labeling scheme of transient versus steady refers to process conditions. For example, process data describing a ramp-up or ramp-down period may represent a transient state, while a steady state of the same process may represent a relatively stable operating condition. Context information surrounding transient as opposed to steady state (as provided in this example labeling scheme) enables an effective cleanup of process data. Using the transient versus steady state labeling scheme on seed data 6, no matter how large or small the subset represented by seed data 6, enables training of SSLA 42 using tags, events, and time period information associated with each of the available labels.

The binary labeling scheme of stable versus unstable labels describes process behavior on a manufacturing line. If SME 34 labels one or more time periods when the process was running in an “ideal” way as opposed to an alternative such as running “poorly,” training unit 76A may use these labels to train SSLA 42 to identify and label instances of these two process behaviors across time periods of unlabeled time series process data 46 to form pre-validation labeled time series process dataset 48. The binary stable versus unstable labeling scheme of this disclosure enables data scientists to utilize relatively advanced supervised types of AI/ML algorithms to correlate and diagnose contributing factors of unstable conditions.

The binary “stable” versus “unstable” labeling scheme of this disclosure has broad applicability across many types of manufacturing processes. In this way, in instances in which training unit 76A trains SSLA 42 using annotated seed 10 with binary stable/unstable labels, SME 34 may essentially identify an “ideal” process behavior period which then enables trained SSL model 44 to annotate unlabeled time series process data 46 using “stable” and “unstable” labels to form pre-validation labeled time series process dataset 48.

In some examples, annotated seed data 10 may be labeled according to a granular labeling scheme of this disclosure. As used herein, a “granular” labeling scheme refers to any labeling scheme of this disclosure that accommodates the use of three or greater labels. One example of a use-case scenario in which annotated seed data 10 may be labeled using a granular labeling scheme of this disclosure relates to roll quality dispositions. For instance, a roll may be scrapped for various reasons, such as scratching, telescoping, thickness uniformity issues, etc. In some examples, cloud data storage system 14 may process annotated seed data 10 to support the recognition of three or greater different labels with respect to events/tags recorded on a manufacturing line.

Examples of tags that are used to generated annotated seed data 10 may vary on an application-to-application basis. Because manufacturing lines may include multiple assets or work items, the tags may focus on one or more specific assets. As one non-limiting example, certain tags of annotated seed data 10 may pertain to readouts from an extruder. for example as opposed to the entire system. SME 34 may provide annotations according to the granular labeling scheme to provide context around the tags of interest, and where applicable, the pertinent problem statement in non-NOC scenarios. Regardless of whether the labeling scheme used is binary or granular, the systems of this disclosure support user-defined labels, which enable SME 34 or other duly authorized users to define the labels on a label-by-label basis.

Again, training unit 76A may train SSLA 42 using annotated seed data 10. In accordance with various aspects of this disclosure, SSLA 42 may represent any of several types of AI/ML models. In some examples, SSLA 42 is a deep learning-based autoencoder model. In some use case scenarios, training unit 76A may train SSLA 42 in an offline phase of SSLA 42 using only NOC data points of annotated seed data 10, thereby enabling the autoencoder of SSLA 42 to derive a latent representation of how NOCs are represented in the underlying dataset. In turn, in an online phase of SSLA 42, SSLA 42 may be subjected to a mix of NOC and anomalous data points, and SSLA 42 may generate form pre-validation labeled time series process dataset 48 (potentially including instances of both NOC predictions and anomalous condition predictions) based on the learnt representations of NOC data points.

In other examples, SSLA 42 is a classical ML-based model, such as an expectation maximization (EM) and naïve Bayes algorithm. In some examples, during an offline phase of the EM & naïve Bayes implementation of SSLA 42, training unit 76A may train SSLA 42 using data subsets of annotated seed data 10 that only include NOC data points as an “expectation step” of the training.

In turn, during an online phase of SSLA 42, SSLA 42 may be subjected to a mix of anomalous condition data points and NOC data points, and may generate a predicted labeled dataset (potentially including instances of both NOC predictions and anomalous condition predictions) based on the learned expectations related to NOC data points. As part of a “maximization step,” training unit 76A may cause SSLA 42 to subject the predicted labeled dataset to another naïve Bayes algorithm, and repeat the generation of the predicted labeled dataset and the re-subjection of the predicted labeled dataset to the naïve Bayes algorithm for a number of iterations until SSLA 42 achieves convergence.

Training unit 76A may designate the post-convergence version of SSLA 42 as a “champion model” to be used to label unlabeled time series process data 46 to, in turn, generate pre-validation labeled time series process dataset 48. It will be appreciated that “convergence” as used in the training phase of the EM & naïve Bayes implementation of SSLA 42 is not necessarily equivalent to the convergence of step 62 of FIG. 3, except in instances of a first-pass approval via SME confirmation of the output.

Irrespective of the underlying (e.g., classical ML-based, deep learning-based, etc.) architecture implemented with respect to SSLA 42, validation unit 76B may subject the output of trained SSL model 44 (namely, pre-validation labeled time series process dataset 48) to the adversarial/reinforcement-based validation operations of this disclosure. For instance, validation unit 76B may feed pre-validation labeled time series process dataset 48 to frontend block 12 in a feedback loop for validation by SME 34, thereby eliciting the entry of output evaluation data 22, which the device(s) of frontend block 12 may provide to cloud data storage system 14 via communications link 72A.

Validation unit 76B may iteratively recurse this feedback loop until validation unit 76B determines, based on output evaluation data 22 and/or other factors, that trained SSL model 44 has reached convergence. Upon validation unit 76B determining that trained SSL model 44 has reached convergence and is in a stable state, deployment unit 76C may deploy trained SSL model 44 to frontend block 12 to be activated in its execution phase to label oncoming manufacturing line process data. The systems of this disclosure are compatible with various granularity levels of tags, such as equipment-level tags, or manufacturing line-wide tags.

In addition to the technical improvements of data precision and scalability described above, the techniques of this disclosure provide several usability improvements as well. For instance, the systems of this disclosure improve the user experience (UX) of process engineers and/or application engineers with respect to tagging process events occurring on factory lines. As another example, feedback of events from trained SSL model 44 may be filtered to eliminate certain outliers or obvious false positives from being output to SME 34.

As another example, the techniques of this disclosure may reduce the time and computing resources consumed by process engineers and/or application engineers in tagging events on the factory lines. In this way, systems of this disclosure improve the accuracy of AI/ML models deployed in manufacturing settings to accelerate the transition towards more efficient digital factory management, while facilitating model validation and monitoring because by making the ground truth data available to aid in evaluating and validating model performance.

With respect to data science, techniques of this disclosure generate labeled datasets that can be used to execute a wide variety of state-of-the-art algorithms which are supervised and can be applied to solve the pressing and complex factory situations. Techniques of this disclosure streamline the feedback loop between data scientists and process engineers will be more streamlined, enabling process engineers to validate model findings with the ground truth data. Additionally, the techniques of this disclosure improve data science productive and help in driving digital factories forward in the development of Industry 4.0.

In the present detailed description of the example embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about” or “approximately” or “substantially.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

The techniques described in this disclosure may be implemented, at least in part, in hardware, software, firmware or any combination thereof. For example, various aspects of the described techniques may be implemented within one or more processors, including one or more microprocessors, CPUs, GPUs, DSPs, application specific integrated circuits (ASICs), field programmable gate arrays (FPGAs), processing circuitry (e.g., fixed function circuitry, programmable circuitry, or any combination of fixed function circuitry and programmable circuitry), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

What is claimed is:

1. A method comprising:
obtaining annotated seed data comprising one or more tags associated with corresponding timing data and a respective label;
training a semi-supervised learning algorithm (SSLA) using the annotated seed data to form a trained semi-supervised learning (SSL) model;
executing the trained SSL model using unlabeled time series process data as an input, wherein the unlabeled time series process data includes tags different from the tags of the annotated seed data to output a pre-validation labeled time series process dataset;
obtaining output evaluation data associated with the pre-validation labeled time series process dataset;
iteratively retraining the trained SSL model using the output evaluation data;
determining that the trained SSL model has reached convergence based on the output evaluation data indicating that the trained SSL model outputs a validated labeled time series dataset; and
in response to determining that the trained SSL model has reached convergence, deploying the trained SSL model.

2. The method of claim 1, wherein each respective label of the annotated seed data is a normal operating condition (NOC) label, and wherein training the SSLA comprises training the SSLA to derive a latent representation of NOC data points in the pre-validation labeled time series process dataset.

3. The method of claim 1, wherein the labels of the annotated seed data include at least one normal operating condition (NOC) label and at least one anomalous condition label.

4. The method of claim 1, wherein the labels of the annotated seed data include at least one of a transient label or a steady state label, wherein each of the transient label and the steady state label are associated with respective process conditions associated with a manufacturing line.

5. The method of claim 1, wherein the labels of the annotated seed data include at least one of a stable label or an unstable label, wherein each of the stable label and the unstable label are associated with respective process behaviors associated with a manufacturing line.

6. The method of claim 1, wherein the labels of the annotated seed data include at least one of a torque spike label or a stable torque label, wherein each of the stable torque label and the torque spike label are associated with respective torque readings associated with a manufacturing line.

7. The method of claim 6, wherein each of the annotated seed data, the pre-validation labeled time series process dataset, and the validated labeled time series process dataset conform to a binary labeling scheme.

8. The method of claim 1, wherein each of the annotated seed data, the pre-validation labeled time series process dataset, and the validated labeled time series process dataset conform to a binary labeling scheme.

9. The method of claim 1, wherein the SSLA comprises a deep learning-based autoencoder model.

10. The method of claim 1, wherein the SSLA comprises an expectation maximization (EM) and naïve Bayes model.

11. A system comprising:
interface hardware configured to obtain annotated seed data comprising one or more tags associated with corresponding timing data and a respective label;
a memory communicatively coupled to the interface hardware, the memory being configured to store the annotated seed data, a semi-supervised learning algorithm (SSLA), and unlabeled time series process data, wherein the unlabeled time series process data includes tags different from the tags of the annotated seed data to output a pre-validation labeled time series process dataset; and
processing circuitry communicatively coupled to the memory and to the interface hardware, the processing circuitry being configured to:
train the SSLA using the annotated seed data to form a trained semi-supervised learning (SSL) model;
execute the trained SSL model using the unlabeled time series process data as an input;
obtain, via the interface hardware, output evaluation data associated with the pre-validation labeled time series process dataset;
iteratively retrain the trained SSL model using the output evaluation data;
determine that the trained SSL model has reached convergence based on the output evaluation data indicating that the trained SSL model outputs a validated labeled time series dataset; and
in response to determining that the trained SSL model has reached convergence, control the interface hardware to deploy the trained SSL model.

12. The system of claim 11, wherein each respective label of the annotated seed data is a normal operating condition (NOC) label, and wherein training the SSLA comprises training the SSLA to derive a latent representation of NOC data points in the pre-validation labeled time series process dataset.

13. The system of claim 11, wherein the labels of the annotated seed data include at least one normal operating condition (NOC) label and at least one anomalous condition label.

14. The system of claim 11, wherein the labels of the annotated seed data include at least one of a transient label or a steady state label, wherein each of the transient label and the steady state label are associated with respective process conditions associated with a manufacturing line.

15. The system of claim 11, wherein the labels of the annotated seed data include at least one of a stable label or an unstable label, wherein each of the stable label and the unstable label are associated with respective process behaviors associated with a manufacturing line.

16. The system of claim 11, wherein the labels of the annotated seed data include at least one of a torque spike label or a stable torque label, wherein each of the stable torque label and the torque spike label are associated with respective torque readings associated with a manufacturing line.

17. The system of claim 16, wherein each of the annotated seed data, the pre-validation labeled time series process dataset, and the validated labeled time series process dataset conform to a binary labeling scheme.

18. The system of claim 11, wherein each of the annotated seed data, the pre-validation labeled time series process dataset, and the validated labeled time series process dataset conform to a binary labeling scheme.

19. The system of claim 11, wherein the SSLA comprises one of a deep learning-based autoencoder model or an expectation maximization (EM) and naïve Bayes model.

20. A non-transitory computer-readable storage medium encoded with instructions that, when executed, cause processing circuitry of a computing device to:
obtain annotated seed data comprising one or more tags associated with corresponding timing data and a respective label;
train a semi-supervised learning algorithm (SSLA) using the annotated seed data to form a trained semi-supervised learning (SSL) model;
execute the trained SSL model using unlabeled time series process data as an input, wherein the unlabeled time series process data includes tags different from the tags of the annotated seed data to output a pre-validation labeled time series process dataset;
obtain output evaluation data associated with the pre-validation labeled time series process dataset;
iteratively retrain the trained SSL model using the output evaluation data;
determine that the trained SSL model has reached convergence based on the output evaluation data indicating that the trained SSL model outputs a validated labeled time series dataset; and
deploy the trained SSL model in response to the determination that the trained SSL model has reached convergence.
